(19) United States
(12) Patent Application Publication
(10) Pub. No.: US 2009/0210340 A1
(43) Pub. Date: Aug. 20, 2009

(54) System and method for managing lending

(76) Inventors: Nishant Mittal, Jersey City, NJ (US); Nimisha Gupta, Jersey City, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/070,344

(22) Filed: Feb. 15, 2008

(51) Int. Cl. G06Q 40/00

(52) U.S. Cl. 705/38

(57) ABSTRACT

An aspect of the present invention provides a method for managing lending, comprising registering participants in a network, linking registrations of participants to form connections between two or more participants, and receiving a request for a loan from a debtor participant registered on the network. The method further comprises transmitting the request to participants linked to the debtor participant, receiving offers to lend money from lender participants in response to the request from the debtor participant, and receiving input from the debtor participant related to acceptance of selected offers.

### CROSS-REFERENCE TO RELATED APPLICATIONS

The present application claims the benefit of the filing date of U.S. Provisional Application No. ______, filed Feb. 15, 2007 and entitled “Procuring Loans From a Network of Friends and Family Based on Trust,” naming Nimisha Gupta as inventor, the disclosure of which is hereby incorporated herein by reference.

### BACKGROUND OF THE INVENTION

Money is required by many people throughout various stages of life. Oftentimes, money is obtained as a loan through banks. Additionally or alternatively, money may be obtained through friends and acquaintances.

Banks typically lend at an interest rate which is similar to the interest rates offered by all other banks. This rate may vary between individual loans, depending on the amount of the loan and the credit history of the applicant. In some circumstances, banks may be unwilling to lend to particular applicants. It may also be impracticable for some individuals to obtain loans from banks. For example, the interest rate may be too high or the loan application process may be too inefficient.

Friends and family may also be approached for loans, but these sources are limited for several reasons. For example, friends and family can only help if they have the money requested at the time and if they trust that the individual will timely repay the full amount. Further, even if friends and family are financially capable of lending the requested amount of money, they may be disinclined to lend. For example, friends and family typically receive no or low interest on loans, whereas putting the money in other investments such as stocks, etc. would likely yield a higher return. In some instances even simply maintaining the money in a savings or investment account may enable accrual of greater interest. Additionally, some individuals may not have many or any friends and family to approach for a loan.

Accordingly, an expanded source of lending may be desired by many individuals. Particularly, a system and method accounting for the deficiencies in current lending options is desired.

### SUMMARY OF THE INVENTION

An aspect of the present invention provides a method for managing lending, comprising registering participants in a network, linking registrations of participants to form connections between two or more participants, and receiving a request for a loan from a debtor participant registered on the network. The method further comprises transmitting the request to participants linked to the debtor participant, receiving offers to lend money from lender participants in response to the request from the debtor participant, and receiving input from the debtor participant related to acceptance of selected offers.

The debtor participant and the lender participant may be contractually bound to their agreement. The request for a loan and/or the offer to lend money, and thus the agreement, may include parameters related to an amount of money, a time for repayment of the loan, and an interest rate for the loan.

This method for managing lending may further comprise rating participants. Even further, a lending-trust metric may be determined based on the rating of a participant. For example, rating participants may include assessing each participant's trustworthiness, and the offers to lend money may be limited by the lender participant's rating or the debtor participant's rating.

Another aspect of the invention provides a system for managing lending. The system may comprise a server and a database containing registrations of participants in the network, wherein the registrations may include information relating to the participants, and wherein registrations of two or more participants may be linked to form connections between the participants. The system may further comprise an interface for the participants to communicate with the server or with other participants, and a processor for processing input from the participants. The participants may input loan requests to be received by selected other participants, and the selected other participants may input offers to lend in response to the request. The offers to lend may be accepted by the participant that input the request.

Yet another aspect of the invention provides a method for making loans, comprising receiving at the server a registration request from a client device. This method may further comprise associating the registration with a participant generating the registration request through the client device, and storing the registration in a database in communication with the server. Moreover, a loan request from a debtor participant may be received at the server, and forwarded to at least one registered participant. The method may also comprise determining at the server a lending-trust metric associated with the debtor participant, forwarding the lending-trust metric to the at least one registered participant, and determining whether to accept the loan request based on the lending-trust metric.

### BRIEF DESCRIPTION OF THE DRAWINGS

FIG. 1 illustrates a system for managing lending in a social network according to an embodiment of the present invention.

FIG. 2 illustrates a method for managing lending in a social network according to an embodiment of the present invention.

FIG. 3 illustrates a method for forming connections for lending in a social network according to an embodiment of the present invention.

FIG. 4 illustrates an interface in a system for managing lending in a social network according to an embodiment of the present invention.

FIG. 5 illustrates a method for distributing information in a social network for lending according to an aspect of the present invention.

FIG. 6 illustrates a method for distributing information in a social network for lending according to another aspect of the present invention.

FIG. 7 illustrates a method for distributing money in a social network for lending according to another embodiment of the present invention.

### DETAILED DESCRIPTION

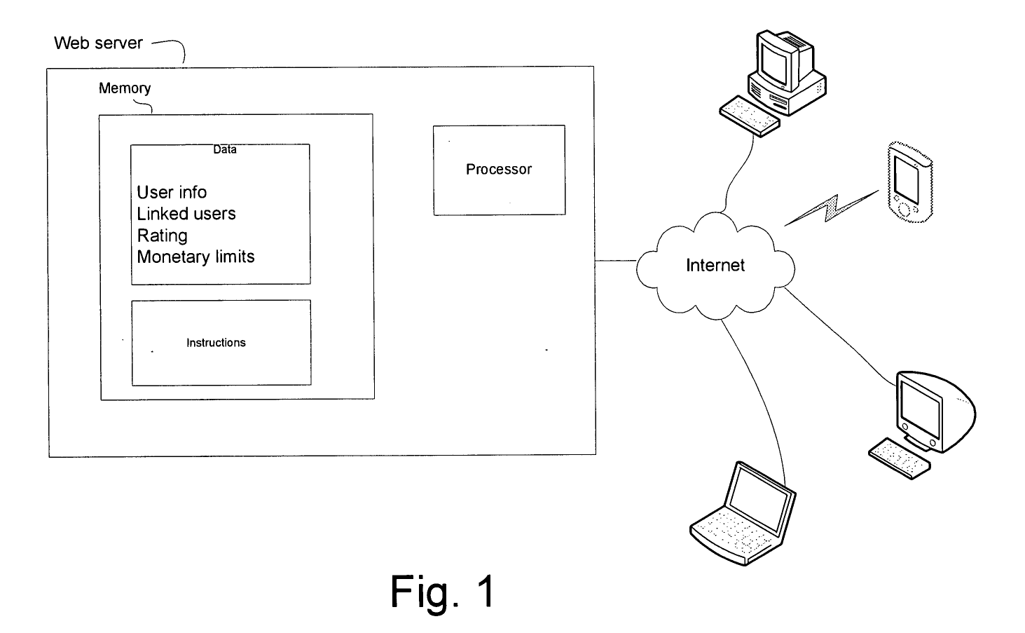

As shown in FIG. 1, a system 100 in accordance with one embodiment of the invention comprises a web server 110, including a processor 150, and a network of computers such as end user personal computers 170-185 that communicate with the server 110 via Internet 160. Although only a few computers are depicted in FIG. 1, in accordance with other aspects of the present invention the system 100 may include a large number of connected computers. Preferably, end user computers 170-185 are general purpose computers having all the internal components normally found in a personal computer, such as a central processing unit (CPU), display, CD-ROM, hard-drive, mouse, keyboard, speakers, microphone, modem and/or router (telephone, cable or otherwise), and any additional components used for connecting these elements to one another. In addition to desktop or laptop personal computers, end user computers 170-185 may comprise any device or client device capable of processing instructions and transmitting data to and from humans and other computers, including network computers lacking local storage capability, PDA's with modems and Internet-capable wireless phones. Although the input means shown in FIG. 1 is the keyboard, other means for inputting information from a human into a computer are also acceptable such as a mouse, a microphone, a touch-sensitive screen, voice recognition, etc.

As shown in FIG. 1, end user computers 170-185 communicate with the Internet 160 via modem or some other communication component such as a network card. Such communications may take place via wired or wireless connections made available through an Internet service provider or other entity that offers a portal to the Internet.

Server 110 contains hardware for sending and receiving information over the Internet or World Wide Web, such as web pages or files. The server 110 may be a typical web server or any computer network server or other automated system capable of communicating with other computers over a network. In accordance with one embodiment of the invention, the server 110 comprises a computer containing a processor 150, memory 120 and other components typically present in general purpose computers.

Memory 120 stores information accessible by processor 150, including instructions 140 for execution by the processor 150 and data 130 which is retrieved, manipulated or stored by the processor 150. The memory 120 may be of any type capable of storing information accessible by the processor 150, such as a hard-drive, ROM, RAM, CD-ROM, write-capable, read-only, or the like.

The instructions 140 may comprise any set of instructions to be executed directly (such as machine code) or indirectly (such as scripts) by the processor. In that regard, the terms “instructions,” “steps” and “programs” may be used interchangeably herein. The functions, methods and routines of the program in accordance with the present invention are explained in more detail below.

Data 130 may be retrieved, stored or modified by processor 150 in accordance with the instructions 140. The data may be stored as a collection of data. For instance, although the invention is not limited by any particular data structure, the data may be stored in computer registers, in a relational database as a table having a plurality of different fields and records, as an XML. The data may also be formatted in any computer readable format such as, but not limited to, binary values, ASCII or EBCDIC (Extended Binary-Coded Decimal Interchange Code). Moreover, any information sufficient to identify the relevant data may be stored along with the data, such as descriptive text, proprietary codes, pointers, or information which is used by a function to calculate the relevant data.

Although the processor 150 and memory 120 are functionally illustrated in FIG. 1 within the same block, it will be understood by those of ordinary skill in the art that the processor 150 and memory 120 may actually comprise multiple processors and memories that may or may not be stored within the same physical housing. For example, some or all of the instructions 140 and data 130 may be stored on removable CD-ROM and others within a read-only computer chip. In addition, some or all of the instructions 140 and data 130 may be stored in a location physically remote from, yet still accessible by, the processor 150. Similarly, the processor 150 may actually comprise a collection of processors which may or may not operate in parallel.

As noted above, the server 110 may comprise additional components typically found in a computer system such as a display (e.g., an LCD screen), user input (e.g., a keyboard, mouse, game pad, touch-sensitive screen), microphone, modem (e.g., telephone or cable modem), and all of the components used for connecting these elements to one another.

Although certain embodiments of the invention operate over the Internet, other embodiments are not limited to any particular type of network. For example, the web server 110 may be a typical web server or any computer network server or other automated system capable of communicating with other computers over wide area networks or local area networks.

Although certain advantages are obtained when information is transmitted or received as noted above, other aspects of the invention are not limited to any particular manner of transmission of information. For example, in some aspects, the information may be send via EDI (electronic data interchange) or some other medium such as a disk, tape, CD-Rom. The information may also be transmitted over a global or private network, or directly between two computer systems, such as via a dial-up modem. In other aspects, the information may be transmitted in a non-electronic format and manually entered into the system.

In addition to the operations illustrated in FIG. 1, an operation in accordance with a variety of aspects of a method for managing lending will now be described. It should be understood that the following operations do not have to be performed in the precise order described below. Rather, various steps can be handled in reverse order or simultaneously. In addition, although this description is provided in the context of a social network of friends and family, in another aspect of the invention the network may comprise any subscriber that can vouch for a person requesting a loan.

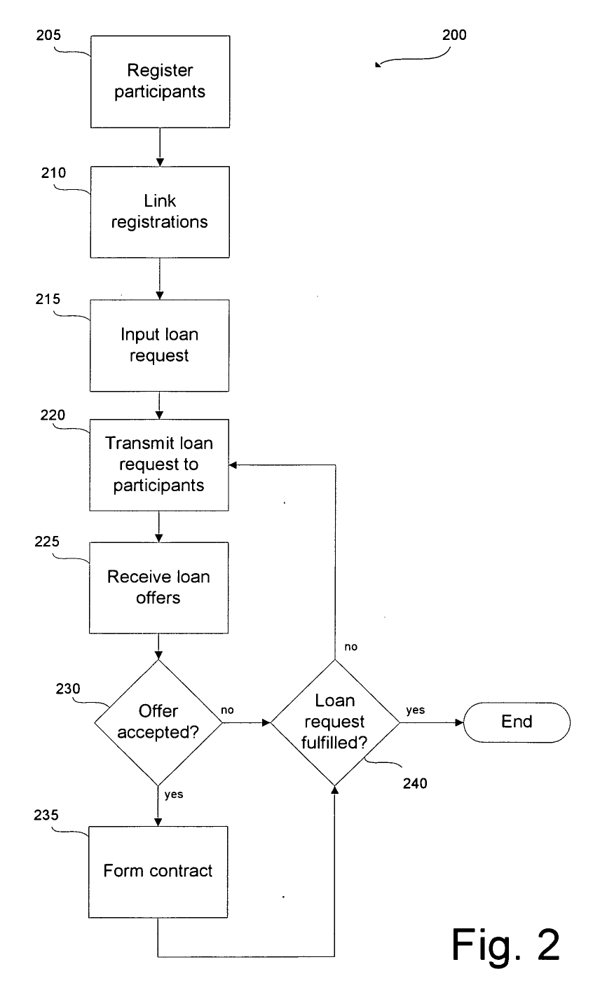

FIG. 2 illustrates a method 200 for managing lending in a social network. In step 205, participants register on the network. Such registrations may be stored in a database coupled to the web server 110, such as memory 120. The registrations may include various types of information received by the participant at initial registration, or received by the participant or others subsequently. The network may be set up so that particular information is required or optional.

Examples of information provided by the participant at initial registration may be user information (e.g., username and password), personal information (e.g., name, date of birth, current employment), and contact information (e.g., address, email address, phone number, website). A participant may also provide financial information, such as income, assets, and credit history, and user preferences. Examples of such user preferences may include specifying information to be kept private.

Other types of information which may be provided by a participant include so-called extras. For example, participants may post blogs, photos, videos, messages, games, etc. This information may be provided at any point during or after registration.

According to one aspect of the invention, participants may create profiles (e.g., a web page), which include various information. The profile may be created automatically by the system using information provided at registration, or may be created manually by the participant. It may be updated as desired by the participant, and access rights may be granted to other participants. For example, some participants may view each other's profiles, post comments and photos to the profile, etc.

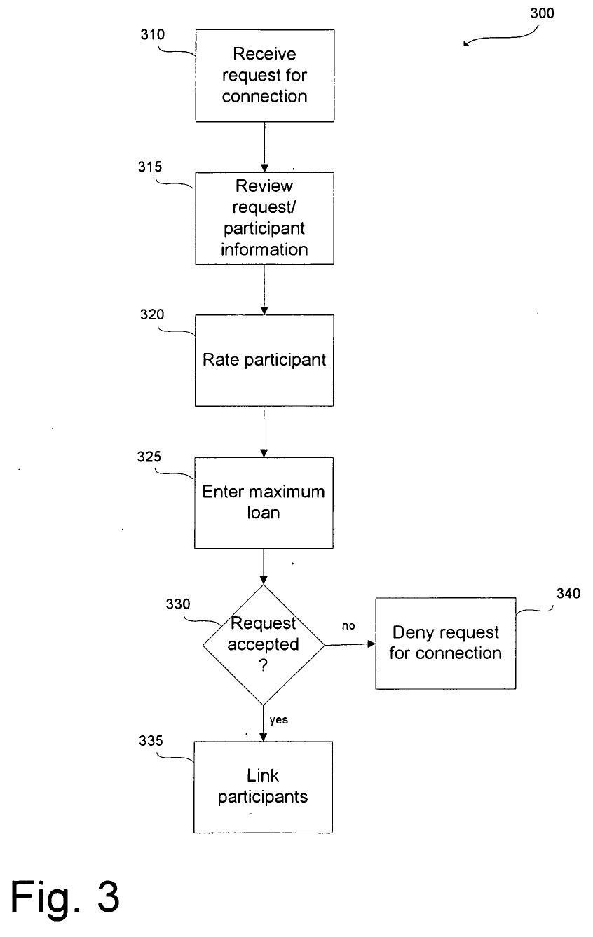

In step 210, registrations associated with two or more participants may be linked. This will be described in more detail with respect to FIG. 3. Participants may be provided with more options or access rights with respect to linked participants than non-linked participants. For instance, a linked participant may be able to view additional profile content and may have extended options for communication with the participant. An example of extended communication options may be the ability to request a loan (step 215).

A participant may input a loan request in step 215 by, for example, filling out a computerized loan request form and submitting the form to the network. The loan request form may include various fields used to specify what type of loan is desired by the participant (hereinafter the “debtor participant”). For example, the loan request form may include one or more drop-down menus pre-populated with various types of loans that may be requested through the network.

Alternatively or additionally, a loan request may include transmission of a message to one or more selected participants. For example, a debtor participant may simply send a personal message to a linked participant requesting to borrow money. According to one aspect, specialized software may monitor transmission of such messages, and provide additional assistance when the messages relate to borrowing or lending of money.

According to one aspect, a debtor participant may be required to specify one or more parameters when formulating the loan request. For example, the debtor participant may be required to enter data in predetermined fields relating to an amount for the loan, an interest rate, and a time for repayment of the loan. The time for repayment of the loan may even include a schedule of the dates when payments are due and the amounts due at each payment. Alternatively or additionally, fields for optional information may be provided. For example, a debtor participant may submit a personal message to be displayed to loan request recipients along with the computerized loan request form.

In specifying loan parameters, the debtor participant may also specify to whom the loan request will be sent (“recipients”). For example, a default setting may exist wherein the request is transmitted to all linked participants. However, the debtor participant may override such setting, and specify only a select few of the linked participants to receive the loan request. Alternatively, the debtor participant may select another setting, such as one which sets the recipients of the loan request to be only the linked participants with the highest ratings.

Once the loan request is entered in step 215, the request may be transmitted to the recipients in step 220. The recipients may review the loan request, including the specified loan parameters, and consider whether to offer a loan. Issues to consider may include terms of repayment, assets currently on hand, a need for such assets during the loan term, and confidence that the debtor participant will repay the loan. As described below, recipients may consider a rating of the debtor participant, where the rating relates to trustworthiness.

In response to the loan request, recipients may submit offers to lend money to the debtor participant, who receives the offers in step 225. The offers may be submitted through a separate computerized form, a personal message, or any other type of communication.

These offers may be for any monetary amount up to the amount requested by the debtor participant. Further, terms of the loan may be specified by the participant offering the loan (hereinafter the “lender participant”). For example, the lender participant may specify an interest rate and a time for repayment. The time for repayment may include even further detail, such as when the first payment is due, the length of time over which repayment may be made, and the interval between payments. These terms may conflict with the terms specified by the debtor participant in the loan request. More preferably, however, the lender participant will respond with loan offers having parameters within a range of acceptable parameters specified by the debtor participant.

Upon considering the offers of each lender participant, the debtor participant may determine whether to accept the offers in step 230. For example, if the debtor participant receives offers with a total exceeding the requested amount, the debtor participant may select only the particular loans needed or the loans with the most preferable repayment terms. Also, if a lender participant makes an offer with parameters outside an acceptable range specified by the debtor participant, the debtor participant may simply decline or ignore the offer. According to a further aspect, the debtor participant may further communicate with the lender participant until they reach mutually agreeable loan terms.

If a particular offer was accepted by the debtor participant in step 230, a binding contract between the debtor participant and the lender participant may be formed in step 235. The contract may include all terms upon which the parties agreed, including loan amount and repayment terms. Optionally, the contract may also include further information proposed by either party and agreed to by the other party.

If one or more offers are declined or ignored in step 230, it may be determined whether the loan request has been fulfilled in step 240. That is, it may be determined whether the total monetary amount of the accepted loans is within a predetermined range of the amount requested in the loan request. If the loan request has been fulfilled, the process may be ended. However, if the loan request has not been fulfilled, the process may return to step 220 and loan requests may be transmitted or re-transmitted to the same or other participants.

According to one aspect, where the debtor participant selected particular linked participants as recipients for the loan request, the debtor participant may be prompted to specify additional recipients. Alternatively, the loan request may automatically be transmitted to all linked participants.

According to another aspect, the loan request may be transmitted to participants that are indirectly linked to the debtor participant. For example, the request may be transmitted to participants that are linked to the original loan request recipients'. That is, if the debtor participant has a list of linked participants (i.e., connections), and those connections each have a separate list of connections (i.e., second-generation connections), the loan request may be transmitted to the second generation connections. The loan request may continually be transmitted through a series of generations of connections until the loan request is satisfied.

According to an even further aspect, the original recipients of the loan request may be prompted to forward the request to selected connections. The recipient may decline this opportunity. However, the recipient may be awarded with a commission for referring a lender participant whose offer is accepted, as described in more detail below. Therefore, original recipients of loan requests may be encouraged to assist in finding one or more other lenders, even if they are unable to make a loan offer themselves.

Debtor and lender participants may be unaware of each other's identities. For example, if a loan request is received by a directly linked participant (i.e., a first generation connection) and forwarded to a second generation connection, the request may be presented as being generated by the first generation connection. In this regard, the second generation does not know whether the request is truly from his immediate connection, or whether his immediate connection forwarded the request from another participant. Similarly, the debtor participant may not know whether a loan offer is from his first generation connection or whether it has been forwarded through his first generation connection from a second generation connection. In fact, the debtor participants may not be provided with any information as to the identities of the lender participants, but rather may only be presented with the loan offer and parameters.

The network may be more beneficial to participants with a greater number of connections. For example, a debtor participant is more likely to satisfy his loan request quickly if he can transmit the request to a greater number of recipients. Participants may find other participants with which to form connections in a number of ways. For example, participants may enter another participant's name or other identifying data in a search field. Alternatively, a participant may browse through all participants registered in the network or in a sub-section of the network. Another option may be to browse through the connections of already linked participants. Even further, a participant may send a message to a non-participant, encouraging the non-participant to register on the network.

FIG. 3 shows an exemplary method 300 that may be used for linking participants to form connections. In step 310, a participant receives a request for connection. The request for connection may include information such as an identification of the requesting participant, a personal message from the requesting participant, or other information. Once the recipient reviews the request for connection in step 315, the recipient may consider whether to accept, deny, or ignore the request.

In considering whether to accept the request, the participant may make certain assessments with respect to the requesting participant. For example, the recipient may rate the participant in step 320. According to one aspect, the rating may relate to the requesting participant's trustworthiness to repay a loan. For example, a participant who is a close friend and has been diligent in repayment of any loans in the past may receive a higher rating than, for example, a participant who is merely a neighbor or an acquaintance. According to an even further aspect, the recipient may be assisted in determining this rating. For example, the recipient of the connection request may be presented with a number of questions. These questions may relate to the requesting participant's trustworthiness, and may be theoretical, historical, or any other type of question. Based on answers to these questions, a rating for the requesting participant may be calculated and recommended to the recipient.

In considering whether to accept the connection request, the recipient may also wish to determine a maximum amount the recipient would be willing to lend the requesting participant in step 325. According to one aspect, this amount may be changed at any point after acceptance of the connection request. Similar to determining the requesting participant's rating, questions and suggestions may be presented to the recipient to assist in making the determination of a maximum loan amount. According to another aspect, the rating and the maximum loan amount may be correlated so that determination of one automatically determines the other.

The recipient may determine whether to accept the connection request in step 330. This decision may be impacted by the participant's rating and maximum loan amount. Alternatively, such factors may be disregarded. If the recipient considers the rating and/or maximum loan amount and is still unsure whether to accept the connection request, the recipient may be presented with a suggestion. For example, calculations may be performed based upon the entered rating, maximum loan amount, and any other data, the result of the calculations determining whether adding the participant as a connection would be beneficial. In other words, these calculations may quantify the risk associated with making a loan to or obtaining a loan from the participant requesting connection. The result of a calculation may be an index rating or metric that the recipient uses to decide whether to make the loan. However, many users may wish to simply accept all connection requests, especially if such acceptance does not create any obligations.

If the recipient accepts the connection request, the recipient and the requesting participant will be linked in step 335. However, if the connection request is not accepted (e.g., if it is denied or ignored) the participants will not be linked.

As mentioned above, participants may assess ratings for other participants. Such assessment may be made in response to a link request, in response to a loan request, in response to fulfillment of an agreement to repay a prior loan, or at any time for any reason. Similarly, the ratings may be updated at any time. Because a participant may be linked to and may interact with a number of other participants, the participant may have a number different ratings. Accordingly, a record of each rating may be stored in a database in communication with the server 110. Additionally, an overall rating (e.g., an average of all ratings assessed by different participants) and a rating history (e.g., a log of all changes to participants' assessments of ratings) may be stored for each participant registration.

The ratings may be assessed based on a predetermined scale. For example, ratings may be numbers ranging from 0 to 100, with 0 being the lowest rating. Alternatively, the ratings may be stars ranging from zero to five, with five stars being the highest rating. Any system or scale may be used.

The ratings assessed by participants may relate to a number of different features. According to one aspect of the invention, the ratings may relate to a participant's trustworthiness. More specifically, if a participant is deemed to be more trusted to repay a loan, that participant will receive a higher rating. Conversely, a participant who is seen as being unreliable may receive a lower rating. Alternatively or additionally, ratings may relate to other factors such as helpfulness (e.g., number or frequency of loans offered), friendliness (e.g., number of connections), and prospect (e.g., likelihood of earning or receiving substantial assets).

Ratings relating at least in part to a level of trust between participants may be affected by the relationship between the participants. For example, participants who are in the same immediate family may provide higher ratings for one another as compared with participants who are merely acquaintances. It should be understood that any number of factors may affect the rating assessed for a particular participant.

According to one aspect of the invention, the network may provide assistance in calculating a rating for a particular participant. For example, a series of questions may be provided to evoke a participant's views of another participant. Each answer provided may correspond to a particular score, with the scores being totaled or averaged to arrive at the suggested rating.

The ratings may be considered by participants in deciding whether to lend money to another participant, and how much money they should lend. For example, a lending-trust metric may be created wherein each rating or range of ratings may correlate to a maximum monetary value. This maximum value may be suggested to the lender participant. According to one embodiment, loans in excess of this maximum monetary value may be prohibited.

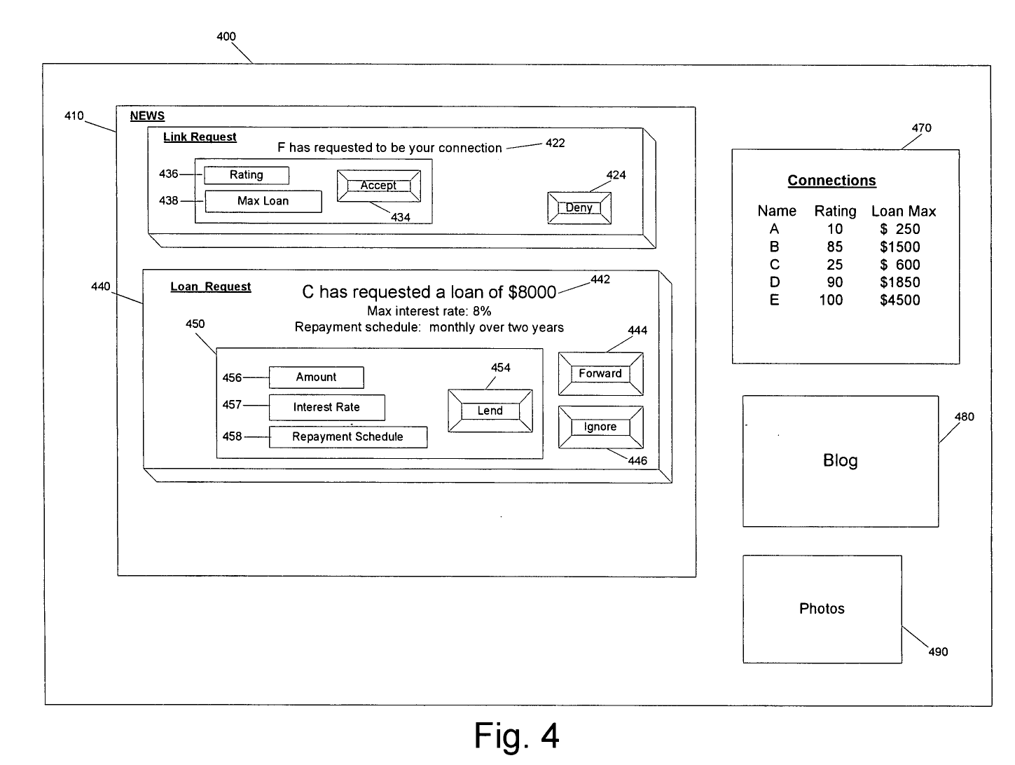

FIG. 4 illustrates a screenshot of the information that may be presented to a participant as described above. Web page 400 shows various features of the social network that may be accessed by the participant. Such features may include, for example, a “News” section 410 featuring link requests 420 and loan requests 440, a “Connections” section 470 featuring linked participants and some of their information, a blog 480, and photos 490. It should be understood by those of skill in the art that further additional features may be accessed by the participant, though not shown in FIG. 4. Examples of such features include message boards, games, search fields, and data entry fields (e.g., loan request forms, profile edit fields, etc.).

The link request notification section 420 may include a link request message 422, indicating to the participant that another participant would like to be linked. According to one aspect, all or part of the link request message 422 may include a hyperlink to further information, such as to the requesting participant's profile page. The participant may consider such information in determining whether to accept or deny the connection request.

If the participant decides to deny the link request, the participant may simply click the “Deny” button 424. According to one aspect, a confirmation screen may appear asking the participant to verify his input. It should be understood by those of skill in the art that although the input mechanism shown is a button, any form of input may be utilized (e.g., voice recognition, etc.).

If the participant decides to accept the link request, he may enter further information relative to the participant requesting connection. For example, input may be a rating of the requesting participant and a maximum amount of any loan to the requesting user, and may be entered by means of drop-down menus 436, 438. Such information may be entered prior or subsequent to accepting the link request 420. Moreover, the information may be updated as desired by the participant. According to one aspect, the information may remain private, and thus will only be displayed to the participant who entered such information. However, according to another aspect, the information may be shared with other participants, including the participant to whom it relates. For example, other participants may be able to view a connections list 470, which may include information relating to each participant's rating and maximum loan amount.

The loan request notification 440 may include a loan request message 442. This message 442 may include information relating to, for example, the requesting participant (i.e., the debtor participant), the maximum interest rate the debtor participant can pay, and a proposed repayment schedule. Upon receiving such a request, the participant may consider whether or not to offer a loan. If the participant does not wish to offer a loan, he may ignore the request by pressing the “Ignore” button 446, or forward the request by pressing the “Forward” button 444.

Alternatively, the participant may decide to offer the debtor participant a loan. In such a case, the participant may specify particular parameters of the loan using, for example, drop-down menus 456, 457, and 458. As shown in FIG. 4, the participant may specify the amount he will lend, the interest rate, and the repayment schedule. However, it should be understood that any parameters the participant determines are a pre-requisite for making the loan may be specified by the participant. For example, the participant may be presented with a dialogue box in which to enter any other parameters desired. Upon specifying the parameters, the participant may enter the offer by pressing the “Lend” button 454. According to one aspect, the participant may offer a loan in addition to forwarding the loan request.

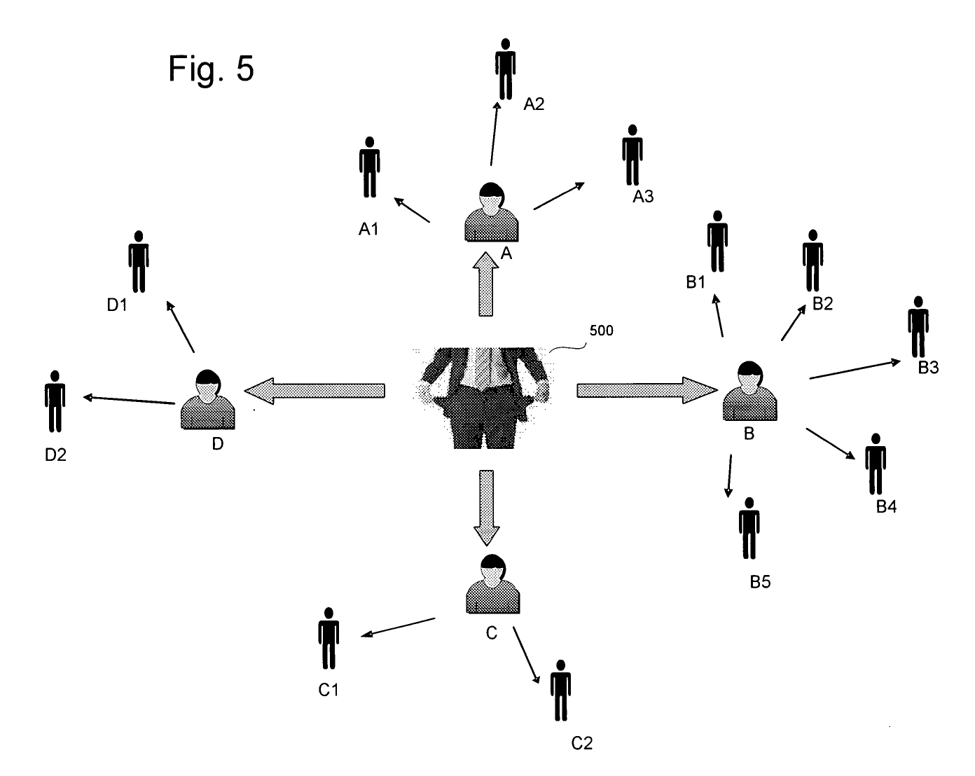

As discussed above, loan requests may be forwarded either automatically if the request is not fulfilled by the debtor participant's direct connections, or manually by individual connections of the debtor participant. FIG. 5 illustrates how the loan request may be dispersed through the network. Participant 500 is registered on the network, and has four connections: participants A, B, C, and D. Participant 500 needs to borrow money, and so enters a loan request into the network. The loan request may be automatically transmitted to each of connections A, B, C, and D, who will be presented with an opportunity to lend money to participant 500. In addition, the loan request may be transmitted to indirect connections of participant 500 (i.e., the connections of A, B, C, and D). Accordingly, the likelihood of participant 500 receiving the full amount of the loan increases as A1, A2, A3, B1, B2, B3, B4, B5, C1, C2, D1, and D2 are also presented with the opportunity to lend.

The loan request may continue to branch out through connections of A1-D2 and so on. According to one aspect of the invention, the loan request will be prevented from forwarding through more than two or three generations of connections in order to minimize risk and maximize the benefits to the participant 500.

According to one aspect, the second generation connections A1-D2 may not be notified that the request was generated by participant 500. Rather, the loan request may be presented as a request from their respective direct connections A-D. That is, A1-A3 would not know whether the loan was for A, or whether A intends to forward the loan to another participant.

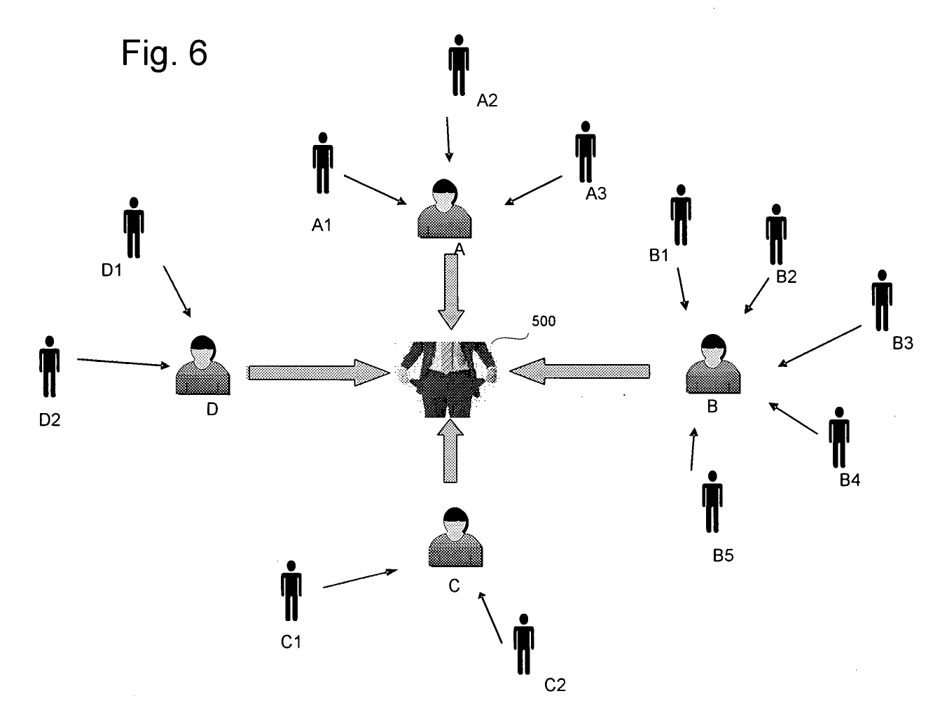

The participant 500's first and second generation connections (and potentially third, fourth, etc. generations, not shown) may extend offers to lend. As shown in FIG. 6, offers may potentially be received by less than all of the participant 500's connections. For example, only connections A and A3, B and B1 and B4, and C and C2 may be willing and able to offer a loan within the parameters specified by the participant 500. However, such offers may nevertheless be sufficient to satisfy the participant 500's request.

Where loan requests and offers are forwarded through first generation connections to second or further generation connections, more than one binding contract may be formed. For example, participant 500 transmits a loan request to C, who forwards the loan request to C2. C2 offers a loan to C, who offers that loan to participant 500. If the participant 500 accepts the offer, a first binding contract may be created between participant 500 and C, and a second binding contract may be created between C and C2.

According to one aspect, loans made through the network may be guaranteed. For example, the network may guarantee loans using funds obtained by commissions, registration fees, transaction fees, donations, or the like. In this regard, lender participants may be encouraged to provide loans because the risk of the debtor participant defaulting may be alleviated.

According to one aspect of the invention, the network may guarantee loans up to a predetermined limit. For example, it may be made clear to participants in the network that only loans up to $2,000 will be guaranteed. Accordingly, if a debtor participant and a lender participant have agreed on a $1,500 loan, and the lender participant subsequently refuses to provide the loan, the network may provide the debtor participant with the $1,500. Similarly, if the lender participant provides the $1,500 loan, and the debtor participant defaults on his repayment, the network may repay the lender participant what he is owed. However, if loans above the limit are agreed upon, only sums up to the limit are guaranteed. That is, if debtor and lender agree to a $4,000 loan, and one of those participants defaults, the network will only provide up to the $2,000 limit. The participants themselves are at risk for the remainder.

According to an aspect, the limit of the guarantee may be a function of the ratings assessed for each participant through which the loan is passed. For example, a type of lending-trust metric may be used. The lending-trust metric may correlate a participant's trustworthiness (e.g., quantified by ratings provided by other participants) with an amount or a dollar range of money that may be loaned to or by the participant. In this regard, ratings may limit the loan amount in at least two different ways. Each of these two ways is discussed below through a separate example.

### EXAMPLE 1

Participant 500 sends a loan request for $3,000 to participant A. A forwards the request to A1. A has an overall rating of 55 (out of a possible 100). Such rating may be a combination (e.g., an average, a median, a minimum) of all the ratings assessed by all linked participants. A1 has a rating of 85. A predetermined loan-rating index indicates that the maximum loan amount for a rating of 55 is $900, and the maximum loan amount for a rating of 85 is $1,600. Thus, A1 may lend up to $1,600, and A may lend up to $900. Although A1 may be willing to lend his maximum amount allowed for his rating (i.e., $1,600) to participant 500, A1 may be limited by A's lower rating, because the loan passes through A. Thus, A1 would only be allowed to lend $900 (A's maximum lending amount).

### EXAMPLE 2

Participant 500 sends a loan request for $3,000 to participant A. A forwards the request to A1. A has assessed a rating of 55 (in response to a link request, the loan request, or at any other time) to participant 500. Similarly, A1 has assessed a rating of 85 to A. The predetermined loan-rating index indicates that the maximum loan amount for a rating of 55 is $900, and the maximum loan amount for a rating of 85 is $1,600. Although A may have otherwise received a loan of $1,600 from A1, because of A1's high rating for A, A may not pass the $1,600 on to participant 500, because of A's lower rating for the participant 500. Accordingly, A may only accept up to $900 of the loan from A1 to pass forward to participant 500.

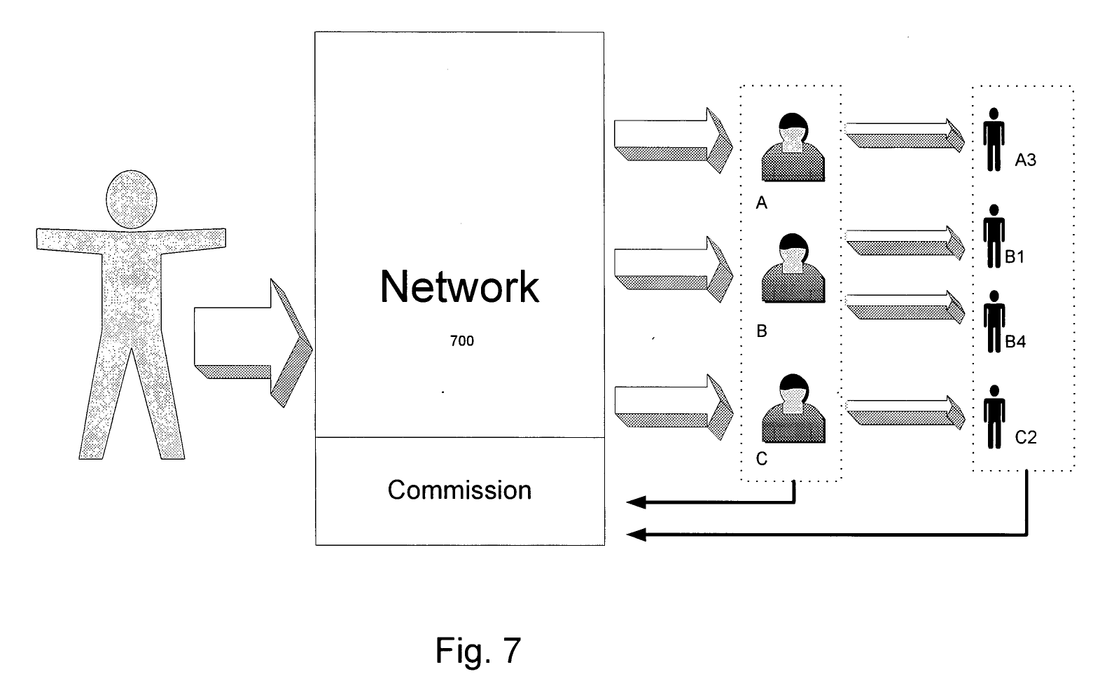

Repayment of the loans may also be made through the network. For example, as shown in FIG. 7, the debtor participant 500 may make a payment to the network, such as an online payment with a credit card. The network may forward payments to the direct connections A, B, and C who contributed loans. Direct connections A, B, and C may each be repaid for their loan contributions, and the remaining sums forwarded to the indirect participants A3, B1, B4, and C2 who contributed loans.

According to one aspect, where loans are forwarded from a second generation connection through a first generation connection (e.g., A3 [symbol] A [symbol] participant 500), repayment of the loan may also be forwarded through that participant. However, according to another aspect, repayment of the loans may be distributed directly to the lender participant, regardless of an indirect connection with the debtor participant.

For each loan request that was fulfilled, the network may take a commission. As shown in FIG. 7, this commission may be taken from the debtor participant, as well as each lender participant. However, according to alternative aspects, commission may be taken from only the debtor participant or first generation lender participants or second generation lender participants, etc. Similarly, different percentage rates may be used to calculate the commissions taken from lender participants and debtor participants.

According to one aspect of the invention, direct lenders A, B, and C may be awarded a commission for obtaining loans from A3, B1, B4, and C2. This commission may be awarded regardless of whether A, B, and C made any contributions to participant 500. Thus, participants may be encouraged to assist in finding a lender even if they themselves are unable to make loan offers. In this regard, participants may be incentivised to expand network connections and build up ratings.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for managing lending, comprising:
transmitting to a server requests to register individual participants in a social network;
storing registrations for the individual participants in a memory;
linking registrations of individual participants to form connections between two or more individual participants;
receiving at the server a request for a loan from a debtor participant registered on the social network;
transmitting the request to one or more individual participants linked to the debtor participant;
receiving one or more offers to lend money from lender participants in response to the request from the debtor participant; and
receiving input from the debtor participant related to acceptance of selected offers.

2. The method for managing lending according to claim 1, further comprising contractually binding the debtor participant and the lender participant.

3. The method for managing lending according to claim 1, wherein the request for a loan includes parameters related to an amount of money.

4. The method for managing lending according to claim 1, wherein the request for a loan includes parameters related to a time for repayment of the requested loan.

5. The method for managing lending according to claim 1, wherein the request for a loan includes parameters related to an interest rate for the requested loan.

6. The method for managing lending according to claim 5, wherein the parameters relating to an interest rate include a maximum interest rate the debtor participant is willing to spend.

7. The method for managing lending according to claim 1, wherein the offer to lend money includes parameters related to an amount of money the lender participant is willing to lend.

8. The method for managing lending according to claim 1, wherein the offer to lend money includes parameters related to a time for repayment of the loan.

9. The method for managing lending according to claim 1, wherein the offer to lend money includes parameters related to an interest rate for the loan.

10. The method for managing lending according to claim 1, wherein the lender participants are indirectly linked to the debtor participant through one or more other participants.

11. The method for managing lending according to claim 10, wherein the request for the loan is transmitted to the indirectly linked lender participant if insufficient offers to lend are received from directly linked participants.

12. The method for managing lending according to claim 1, wherein an identity of the lender participant is unknown to the debtor participant.

13. The method for managing lending according to claim 1, wherein an identity of the debtor participant is unknown to the lender participant.

14. The method for managing lending according to claim 1, further comprising rating participants.

15. The method for managing lending according to claim 14, further comprising determining a lending-trust metric based on the rating of participants.

16. The method for managing lending according to claim 14, wherein the offers to lend money are limited by the lender participant's rating.

17. The method for managing lending according to claim 14, wherein the offers to lend money are limited by the debtor participant's rating.

18. The method for managing lending according to claim 1, wherein the step of creating user registrations includes inputting an amount of money a participant is willing to lend through the network.

19. The method for managing lending according to claim 1, wherein the step of linking user registrations requires a participant to input data related to levels of trust between participants.

20. The method for managing lending according to claim 1, further comprising guaranteeing repayment of loaned money.

21. The method for managing lending according to claim 20, wherein the step of guaranteeing repayment is limited by predefined factors.

22. A system for managing lending, comprising:
a server;
a database containing registrations of individual participants in a social network, wherein the registrations may include information relating to the individual participants, and wherein registrations of two or more participants may be linked to form connections between the participants;
an interface for the participants to communicate with the server or with other participants; and
a processor programmed to process input data from the participants, the input data including one or more loan requests and one or more responses to the loan requests.

23. The system for managing lending of claim 22, wherein the information relating to the participants includes information selected from the group consisting of personal information, financial information, information relating to linked participants and rating information.

24. The system for managing lending of claim 23, wherein the financial information includes a maximum amount of money the participant is willing to lend.

25. The system for managing lending of claim 24, wherein the financial information includes individual maximum amounts of money the participant is willing to lend to selected other participants.

26. The system for managing lending of claim 23, wherein the rating information includes an assessment made by a lender participant.

27. The system for managing lending of claim 23, wherein the rating information includes an overall rating.

28. The system for managing lending of claims 23, wherein the rating information relates to a lending-trust metric.

29. The system for managing lending of claim 22, wherein the interface is a graphical user interface.

30. The system for managing lending of claim 22, wherein the interface is remote from the server.

31. The system for managing lending of claim 22, wherein the processor may be programmed to automatically transmit requests for loans to selected participants in response to a participant's input.

32. A method for making loans, comprising:
receiving at a server a registration request from one or more client device;
associating a registration with an individual participant in a social network;
receiving at the server a loan request from a debtor participant;
determining at the server a lending-trust metric associated with the debtor participant; and
forwarding by the server the loan request to at least one registered individual participant.

33. The method for making loans according to claim 32, further comprising forwarding the loan request from the at least one registered participant to at least one other participant.

34. The method for making loans according to claim 32, further comprising storing the registration in a database in communication with the server.

35. The method for making loans according to claim 32, further comprising forwarding the lending-trust metric to the at least one registered participant.

36. The method for making loans according to claim 32, wherein determining further comprises calculating the trust metric based on a participant.

37. An apparatus, comprising:
a memory containing executable instructions; and
a processor programmed using the instructions to:
receive registration information of one or more individual users;
selectively link the registration information associated with a plurality of individual users;
receive a loan request from a debtor user;
receive one or more offers to lend money from other registered individual users in response to the loan request; and
transmitting a message to the debtor user indicating denial or acceptance of the loan request.
